(19) United States
(12) Patent Application Publication
(10) Pub. No.: US 2017/0198640 A1
(43) Pub. Date: Jul. 13, 2017

(54) DEVICE AND METHOD FOR PRE-HEATING FUEL IN A TURBOMACHINE

(71) Applicant: Safran Power Units, Toulouse (FR)

(72) Inventor: Alban Depoutre, Moissy-Cramayel (FR)

(73) Assignee: Safran Power Units, Toulouse (FR)

(21) Appl. No.: 15/313,526

(22) PCT Filed: May 22, 2015
(86) PCT No.: PCT/FR2015/051349

§ 371 Date: Nov. 22, 2016

(30) Foreign Application Priority Data
May 26, 2014 (FR) 1454737

(51) Int. Cl. F02C 7/224; F02C 7/232

(52) U.S. Cl. CPC F02C 7/224; F02C 7/232; F05D 2220/323

(57) ABSTRACT

The invention relates to a device (30, 31, 39, 42) for preheating a fluid for supplying fuel injectors, comprising a fuel circuit comprising an electric pump (12, 44) controlled by an electronic power module (18). A bypass pipe (27) makes it possible to allow or prevent the flow of fuel to the equipment. According to the invention, the device comprises means for increasing the pressure difference between the inlet and outlet of the pump (22, 44), these means being arranged in the bypass pipe (27).

The present invention relates to a device for preheating a fluid and a method using the device.

The invention applies more particularly to aircraft engines, that is to say both to aeroplane engines (turbojet engines, turboprop engines) and to helicopter turbine engines as well as to non-propulsive power generators.

More specifically, auxiliary power unit (APU) designates an auxiliary unit (in general a turbogenerator) intended to produce energy (electrical, pneumatic pressure) onboard aeroplanes in order to supply on the ground the various onboard systems when the engines used for propulsion of the aeroplane are stopped in order to save on fuel or to start the propulsion engines. The APU may or may not be used in flight. In the case of aeroplanes, APUs are generally positioned at the rear of the aircraft, in the tail cone, and comprise fuel injectors in a combustion chamber.

Starting an auxiliary power unit must be able to be done when it is cold, that is to say after a prolonged period of immobilisation or in the case of cold outside temperatures on the ground or at altitude.

In order to correctly achieve the ignition of the fuel combustion in the combustion chamber, it is necessary for the fuel injected to be metered in a suitable proportion. This is because the ratio of the fuel flowrate to the air flowrate corresponding to the fuel percentage must be suitable. An excessively low fuel percentage does not enable the combustion chamber to be ignited, while an excessive percentage leads to excessively great increase in the temperature in the combustion chamber that may impact on the correct functioning of the auxiliary power unit.

It should also be noted that the high viscosity of the fuel under cold conditions degrades the quality of the spray of fuel atomised by the injectors and reduces performance on ignition.

To facilitate the ignition of the combustion chamber, preconfiguring the laws regulating the flowrate of fuel injected into the combustion chamber according to the ambient temperature and/or the temperature of the fuel is thus known. These laws are also determined according to the component used for apportioning the fuel. However, these laws are determined in the factory and do not take account of the actual parameters of the engine in operation, such as the rotation speed of the main rotor of the APU engine, the external temperature or the altitude of the aircraft, and hence the flowrate of fuel injected is never optimum.

In addition, improving the control of the metering proves to be tricky and expensive to implement. Finally, none of the current technical solutions makes it possible to preheat the fuel on start-up, which would make it possible to reduce the viscosity of the fuel and would thus limit the impact on the metering of the fuel.

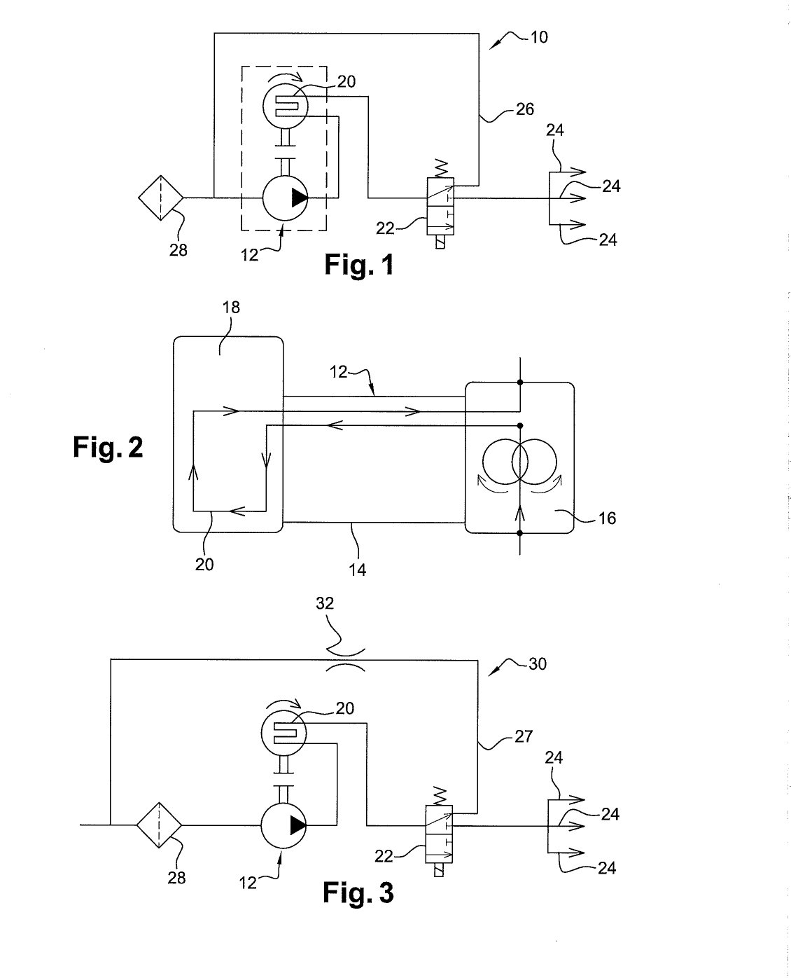

FIG. 1 shows a part of a fuel circuit 10 in an APU, the circuit 10 comprising a fuel-metering pump 12 formed by an electric motor 14 connected to a geared pump 16. The electric pump 14 is controlled by an electronic power module 18 arranged in contact with a portion of the fuel circuit 20 so as to form a heat exchanger.

The circuit 10 also comprises a valve 22 able to be moved between the first position and a second position. In the first position, the valve 22 prevents the flow of fuel to the fuel injectors 24 and allows recirculation of the fuel in a bypass pipe 26, the downstream end of which emerges upstream of the geared pump 16 and downstream of a fuel filter 28. In its second position, the valve 22 allows the flow of fuel to the injectors 24 and blocks the flow of fuel in the bypass pipe 26.

The use of a bypass pipe 26 makes it possible to create a permanent closed circulation loop for fuel when the valve 22 is in its first position, by means of the pump 12 functioning for example at tick over. In this position, the fuel present in the loop of the fuel circuit 10 is heated by means of the heat produced by the electronic power module 18 and yielded up in the heat exchanger to the fuel.

However, as indicated previously, the heating of the fuel proves insufficient and the result is the previously disclosed difficulties of metering the fuel and consequently the ignition of the combustion of the fuel in the chamber. Adding a heating component for the fuel specifically provided for preheating the fuel is not recommended since this leads to an increase in the mass, causing an increase in the fuel consumption of the aeroplane.

The aim of the invention is in particular to afford a simple, economical and effective solution to these problems making it possible at least partly to avoid the aforementioned drawbacks.

To this end, it relates to a device for preheating a fluid for supplying an item of equipment, comprising a fluid circuit comprising an electric pump controlled by an electronic power module, a heat exchanger able to exchange heat between the electronic power module and the fluid in the circuit, a bypass pipe connecting the downstream side of the heat exchanger and of the electric pump to the upstream side of the heat exchanger and of the electric pump, and a valve able to adopt a first position in which it prevents the circulation of fluid to an item of equipment and allows the circulation of fluid in the bypass pipe, and a second position in which it allows the circulation of fluid in the equipment and prevents the circulation of fluid in the bypass pipe, the device further comprising means for increasing the pressure difference between the inlet and outlet of the pump, these means being arranged in the bypass pipe.

According to the invention, integrating the means for increasing the pressure difference makes it possible to increase the power consumed by the electric pump and therefore to increase the temperature rise in the fuel circulating in a loop when the valve is in its first position.

When the valve is moved into its second position, the fuel is thus sufficiently preheated to supply injectors and to allow ignition of the combustion chamber without difficulty. These means of increasing the pressure are advantageously active only when the valve is in its first position so as not to have an effect on the flowrate of fuel supplying the equipment when the pump is in its second position.

Thus, unlike the prior art, the starting of the combustion chamber of an APU can thus be done with hot fuel, the viscosity of which enables it to be metered in an optimum manner for supplying the injectors and for good atomisation.

Ideally, the volume of fuel recirculating is determined so as to correspond to the volume of fuel necessary for achieving starting of the APU.

After the phase of ignition of the fuel, the volume previously preheated is exhausted and the chamber is supplied with cold fuel issuing from the tanks, which no longer poses any particular difficulties since the regulation system takes control of the engine of the APU, that is to say it continuously adjusts the quantity of fuel atomised in the combustion chamber according to the operating parameters of the engine so that the latter reaches its nominal operating speed.

According to another feature of the invention, the valve is arranged downstream of the heat exchanger and pump.

Preferentially, the heat exchanger is arranged downstream of the fluid pump and upstream of the valve.

In a practical embodiment of the invention, the valve is a three-way valve of the type with a spool able to move in translation or a solenoid valve between the first and second positions.

According to another feature of the invention, the means for increasing the pressure difference are integrated in the valve.

In one embodiment of the invention, the means for increasing the pressure difference are integrated in the valve.

In one embodiment of the invention, the means for increasing the pressure difference comprise a region with a reduced cross section.

In another embodiment of the invention, the means for increasing the pressure difference comprise a flap valve configured so as to open at a predetermined threshold pressure.

A filter may be arranged downstream of the downstream end of the bypass pipe and upstream of the electric pump.

The device according to the invention is particularly advantageous when the fluid is fuel and the equipment is a manifold supplying fuel to injectors in a combustion chamber.

The invention also relates to an aircraft engine comprising a preheating device as described above.

The invention also relates to a method for starting an engine for an aircraft comprising a fluid circuit comprising an electric pump controlled by an electronic power module, a heat exchanger able to exchange heat between the electronic power module and the fluid in the circuit, a bypass pipe connecting the downstream side of the heat exchanger and of the electric pump to the upstream side of the heat exchanger and of the electric pump, and a valve able to adopt a first position in which it prevents the flow of fluid to an item of equipment and allows the flow of fluid in the bypass pipe, and a second position in which it allows the flow of fluid in the equipment and prevents the flow of fluid in the bypass pipe, the method comprising a phase of preheating the fuel in the bypass pipe when the valve is in the first position.

In particular, the starting method consists of maintaining the valve in its first position for the time necessary for the fluid to reach a predetermined temperature and then positioning the valve in its second position to allow the flow of fluid to the equipment.

The invention will be understood better and other details, advantages and features of the invention will emerge from a reading of the following description given by way of non-limitative example, with reference to the accompanying drawings, in which:

FIG. 1 is a schematic view of a fuel circuit according to the prior art and already described;

FIG. 2 is a schematic view to a larger scale of the area delimited in broken lines in FIG. 1;

FIG. 3 is a schematic view of a fuel circuit according to a first embodiment of the invention, the valve being in a first position;

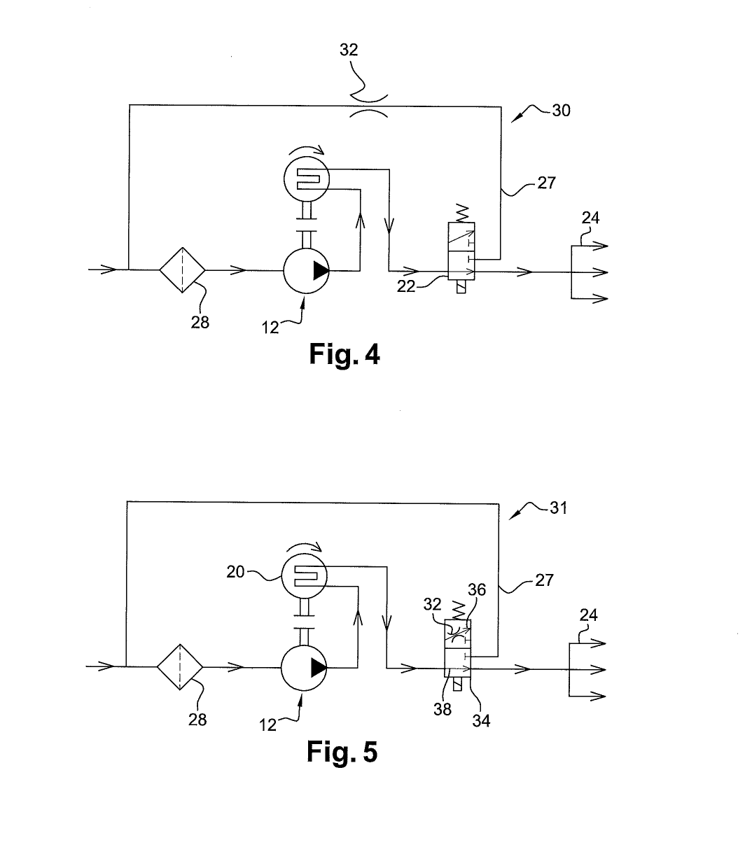

FIG. 4 is a schematic view of a fuel circuit according to a first embodiment of the invention, the valve being in a second position;

FIG. 5 is a schematic view of a fuel circuit according to a second embodiment of the invention;

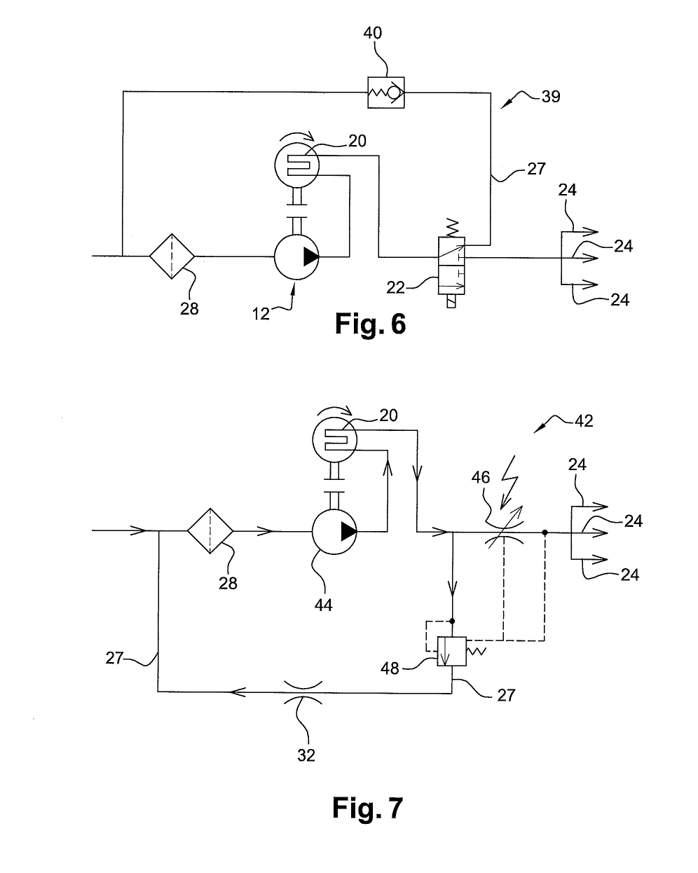

FIG. 6 is a schematic view of a fuel circuit according to a third embodiment of the invention;

FIG. 7 is a schematic view of a fuel circuit according to a fourth embodiment of the invention.

Reference is made first of all to FIG. 3, showing a fuel-preheating device according to the invention, the same reference numbers designating elements similar or identical to those described with reference to FIGS. 1 and 2.

The device 30 according to the invention comprises means 32 for increasing the pressure difference. In the embodiment in FIGS. 3 to 5, these means are formed by a zone 32 with a reduced cross section compared with the rest of the bypass pipe 27.

In operation, when the valve 22 is in its first position (FIG. 3), the pump 12 is controlled and supplied with electrical energy by the power module 20. The energy dissipated by the electric motor 14 and the electronic power module 18 is transmitted to the fuel by the portion 20 of the circuit forming a heat exchanger.

The zone with a reduced cross section 32 makes it possible to create a pressure drop providing an increase in the pressure difference between the upstream side and downstream side of the pump 12, which increases the pressure consumed by the pump and causes an increase in the temperature of the fuel.

Thus, according to the invention, integrating a zone with a reduced cross section 32 makes it possible to increase more rapidly the temperature of the fuel circulating in the loop compared with a system without a zone with a reduced cross section, when the valve 22 is in its first position.

When the operator wishes to effect an ignition of the combustion chamber, the valve 22 is moved into its second position (FIG. 4), and the heated fuel thus flows in the direction of the fuel injectors, which guarantees a lower viscosity of the fuel and facilitates the metering and atomisation of the fuel supplying the chamber.

After the ignition of the combustion chamber, the quantity of fuel preheated in advance is exhausted and the combustion chamber is supplied with cold fuel coming from the aeroplane fuel tanks. Supplying the combustion chamber no longer poses any difficulties since the combustion chamber is ignited and the regulation system takes control of the engine, that is to say it continuously adjust the quantity of fuel in the combustion chamber according to the parameters of the engine so that the latter reaches its nominal operating speed (closed-loop control system).

In order to increase the quantity of hot fuel supplying the combustion chamber, the filter 28 is thus positioned so that the downstream end of the bypass pipe 27 emerges upstream of the filter 28.

In a second embodiment of the device depicted in FIG. 5, the zone with a reduced cross section 32 is integrated in the valve 34. In practice, the valve 34 may be of the type comprising a first channel 36 supplying the bypass pipe 27 and a second channel 38 supplying the injectors 24. The zone with a reduced cross section 32 can thus be integrated in the first channel 36.

In a third embodiment of the device 39 depicted in FIG. 6, the means for increasing the pressure difference comprise a flap valve 40 with a spring mounted on the bypass pipe 27 so as to allow flow of fuel when the pressure is above a threshold pressure and to prevent the flow of fuel when the pressure is below this threshold pressure.

In a fourth embodiment of the device 42 depicted in FIG. 7, the electric pump 44 does not provide the metering of the fuel, which is then provided by an independent metering component 46, such as a servo valve, positioned between the upstream end of the bypass pipe 27 and the fuel injectors 24.

In this embodiment, the valve 48 is arranged in the bypass pipe 27, between the zone with a reduced cross section 32 and the upstream end of the bypass pipe 27.

In practice, the metering component 46 may be a variable-opening valve that can be completely closed to prevent the flow of fuel to the injectors 24.

In this configuration, the recirculation of the fuel in the bypass pipe 27 to heat it is guaranteed.

When the first valve 48 prevents the circulation of fuel in the bypass pipe 27, the component 46 then allows the flow of fuel to the injectors 24.

The invention is thus particularly advantageous in the case of an auxiliary power unit but is of course equally applicable to any type of turbojet engine or turbine engine requiring starting in an environment where the fuel is cold.

1. A device for preheating fuel for supplying an item of equipment, comprising:
a fuel circuit comprising an electric pump controlled by an electronic power module, a heat exchanger able to exchange heat between the electronic power module and the fuel in the circuit, a bypass pipe connecting the downstream side of the heat exchanger and of the electric pump to the upstream side of the heat exchanger and of the electric pump, and a valve able to adopt a first position in which it prevents the circulation of fuel to an item of equipment and allows the circulation of fuel in the bypass pipe, and a second position in which it allows the circulation of fuel in the equipment and prevents the circulation of fuel in the bypass pipe,
the device further comprising means for increasing the pressure difference between the inlet and outlet of the pump, these means being arranged in the bypass pipe.

2. A device according to claim 1, in which the valve is arranged downstream of the heat exchanger and of the pump.

3. A device according to claim 1, in which the heat exchanger is arranged downstream of the fuel pump and upstream of the valve.

4. A device according to claim 1, in which the valve is a three-way valve of the spool type or a solenoid valve that can be moved between the first and second positions.

5. A device according to claim 4, in which the means for increasing the pressure difference are integrated in the valve.

6. A device according to claim 1, in which the means for increasing the pressure difference comprise a zone with a reduced cross section.

7. A device according to claim 1, in which the means for increasing the pressure difference comprise a flap valve configured so as to open at a predetermined threshold pressure.

8. A device according to claim 1, in which a filter is arranged downstream of the downstream end of the bypass pipe and upstream of the electric pump.

9. A device according to claim 1, in which the equipment is a manifold supplying fuel to injectors in a combustion chamber.

10. An aircraft engine comprising a preheating device according to claim 1.

11. A method for starting an engine for an aircraft comprising a fuel circuit comprising an electric pump controlled by an electronic power module, a heat exchanger able to exchange heat between the electronic power module and the fuel in the circuit, a bypass pipe connecting the downstream side of the heat exchanger and of the electric pump to the upstream side of the heat exchanger and of the electric pump, and a valve able to adopt a first position in which it prevents the flow of fuel to an item of equipment and allows the flow of fuel in the bypass pipe, and a second position in which it allows the flow of fuel in the equipment and prevents the flow of fuel in the bypass pipe, the method comprising a phase of preheating the fuel in the bypass pipe when the valve is in the first position.

12. A starting method according to claim 11, in which the preheating phase consists of maintaining the valve in its first position for the time necessary for the fuel to reach a predetermined temperature and then positioning the valve in its second position to allow the flow of fuel to the equipment.
